(19) United States
(12) Patent Application Publication
(10) Pub. No.: US 2018/0330543 A1
(43) Pub. Date: Nov. 15, 2018

(54) DIRECTIONAL VIDEO FEED AND AUGMENTED REALITY SYSTEM

(71) Applicant: Trevor Shand, Charlottesville, VA (US)

(72) Inventor: Trevor Shand, Charlottesville, VA (US)

(21) Appl. No.: 15/590,436

(22) Filed: May 9, 2017

(51) Int. Cl. G06T 19/00; G01C 21/36; G01S 5/16

(52) U.S. Cl. CPC G06T 19/006; G01C 21/3647; G01S 5/163; G09G 2340/125; G06T 2219/20; G09G 2340/12; G01C 21/36

(57) ABSTRACT

The present invention examines location and orientation of a mobile device (e.g., smartphone or wearable device) to select a video feed from a plurality of available video sources in communication with the mobile device via a network. The respective locations and orientations of the video sources are stored. A program, executing on the mobile device, uses GPS and accelerometers to establish the mobile device's location and orientation. Using the stored information about the video sources' locations and orientations and the mobile device's determined location and orientation, the program decides which video feed is appropriate and requests that feed from the respective video source. As the location and orientation of the mobile device changes, the program continues to compare the mobile device's location and orientation with the location and orientation information of the available video sources and requests new video feeds as needed in real-time.

### BACKGROUND OF THE INVENTION

### 1. Field of Invention

The present invention relates to location and orientation based video presentation and augmented reality.

### 2. Description of Related Art

Augmented reality (AR) is a live direct or indirect view of a physical, real-world environment whose elements are augmented (or supplemented) by computer-generated sensory input such as sound, video, graphics, or data. It is related to a more general concept called mediated reality, in which a view of reality is modified by a computer. As a result, the technology functions by enhancing one's current perception of reality. By contrast, virtual reality replaces the real world with a simulated one.

Traditional Video Management Software (VMS), such as those from IP Configure, L3 Klein, and OnSSI, display video feeds on a monitor or screen and allow a user to change camera feeds using a mouse click, a screen tap, or other manual actions.

There exists a need to use mobile technology, location, and orientation, along with improved video management software to automatically enhance a users' experience and knowledge of their surroundings via augmented reality.

### SUMMARY OF THE INVENTION

The present invention facilitates augmented reality through a mobile device that comprises a video display and audio output. Software and/or hardware determines the location and orientation of the mobile device at a particular time, and uses such to automatically select and display a video feed from a plurality of available video sources, which may include live video capture device disposed at various locations and/or orientations remote to the mobile device. As the location and/or orientation of the mobile device significantly changes, the selection and display of the applicable video feed changes concurrently therewith. The location and orientation of the mobile device dictates the selection and display of a respective video feed from the plurality of available video sources.

In an embodiment of the invention, a method comprises the steps of: determining a first location and a first orientation of a mobile device; selecting, based on the determined first location and first orientation of the mobile device, a first video feed from among a plurality of video feeds associated with a plurality of video sources; and displaying the first video feed at the mobile device. Each video source is associated with a respective video source location and a respective video source orientation. The step of selecting comprises the step of comparing the first location and the first orientation of the mobile device to the respective video source location and the respective video source orientation of each video source. The method may further comprise the steps of: determining a second location and second orientation of a mobile device; selecting, based on the determined second location and second orientation of the mobile device, a second video feed from among a plurality of video feeds associated with a plurality of video sources; and displaying the second video feed at the mobile device. The method may further comprise the steps of: selecting, based on the determined first location and first orientation of the mobile device, a second video feed from among a plurality of video feeds associated with a plurality of video sources; and displaying the first video feed combined with the second video feed at the mobile device. The method may further comprise the steps of: augmenting the display of the first video feed with an indicator to move the mobile device to a second location and/or second orientation; detecting movement of the mobile device to the second location and/or second orientation; selecting, based on the second location and/or second orientation, a second video feed from among a plurality of video feeds associated with a plurality of video sources; and displaying the second video feed at the mobile device. The step of augmenting the display occurs when a predetermined event is detected at a video source associated with the second video feed.

In another embodiment of the invention, a non-transient computer readable medium containing program instructions for causing a computer to perform the method of: determining a first location and a first orientation of a mobile device; selecting, based on the determined first location and first orientation of the mobile device, a first video feed from among a plurality of video feeds associated with a plurality of video sources; and displaying the first video feed at the mobile device. Each video source is associated with a respective video source location and a respective video source orientation. The step of selecting comprises the step of comparing the first location and the first orientation of the mobile device to the respective video source location and the respective video source orientation of each video source. The method may further comprise the steps of: determining a second location and second orientation of a mobile device; selecting, based on the determined second location and second orientation of the mobile device, a second video feed from among a plurality of video feeds associated with a plurality of video sources; and displaying the second video feed at the mobile device. The method may further comprise the steps of: selecting, based on the determined first location and first orientation of the mobile device, a second video feed from among a plurality of video feeds associated with a plurality of video sources; and displaying the first video feed combined with the second video feed at the mobile device. The method may further comprise the steps of: augmenting the display of the first video feed with an indicator to move the mobile device to a second location and/or second orientation; detecting movement of the mobile device to the second location and/or second orientation; selecting, based on the second location and/or second orientation, a second video feed from among a plurality of video feeds associated with a plurality of video sources; and displaying the second video feed at the mobile device. The step of augmenting the display occurs when a predetermined event is detected at a video source associated with the second video feed.

In yet another embodiment of the invention, a mobile device comprises: means for determining location of the mobile device; means for determining orientation of the mobile device; a display; a processor; and a non-transient computer readable medium containing program instructions for causing the processor to: determine a first location and a first orientation of a mobile device; select, based on the determined first location and first orientation of the mobile device, a first video feed from among a plurality of video feeds associated with a plurality of video sources; and display the first video feed on the display. Each video source is associated with a respective video source location and a respective video source orientation. The program instructions further cause the processor to: determine a second location and second orientation of a mobile device; select, based on the determined second location and second orientation of the mobile device, a second video feed from among a plurality of video feeds associated with a plurality of video sources; and display the second video feed on the display. The program instructions further cause the processor to: select, based on the determined first location and first orientation of the mobile device, a second video feed from among a plurality of video feeds associated with a plurality of video sources; and display the first video feed combined with the second video feed on the display. The program instructions further cause the processor to: augment the display of the first video feed with an indicator to move the mobile device to a second location and/or second orientation; detect movement of the mobile device to the second location and/or second orientation; select, based on the second location and/or second orientation, a second video feed from among a plurality of video feeds associated with a plurality of video sources; and display the second video feed on the display.

An advantage of the present invention is that it provides a more instinctive experience by displaying a natural video feed expected in an automated fashion. The present invention reduces confusion of what video feed is where by ensuring the user is always oriented toward the most applicable video source. It reduces fatigue of needing to manually refresh/select/update video feeds by automating the switch and allows the use of video sources to lead the user by knowing where both the video camera and user are located. The present invention effectively manages a large number of cameras through a unique algorithm assisting the user.

The foregoing, and other features and advantages of the invention, will be apparent from the following, more particular description of the preferred embodiments of the invention, the accompanying drawings, and the claims.

### BRIEF DESCRIPTION OF THE DRAWINGS

For a more complete understanding of the present invention, the objects and advantages thereof, reference is now made to the ensuing descriptions taken in connection with the accompanying drawings briefly described as follows:

FIGS. 1A and 1B illustrate a video feed system 100 according to an exemplary embodiment of the invention; and

FIG. 2 illustrates a mobile device 103 according to an embodiment of the invention.

### DETAILED DESCRIPTION OF EMBODIMENTS

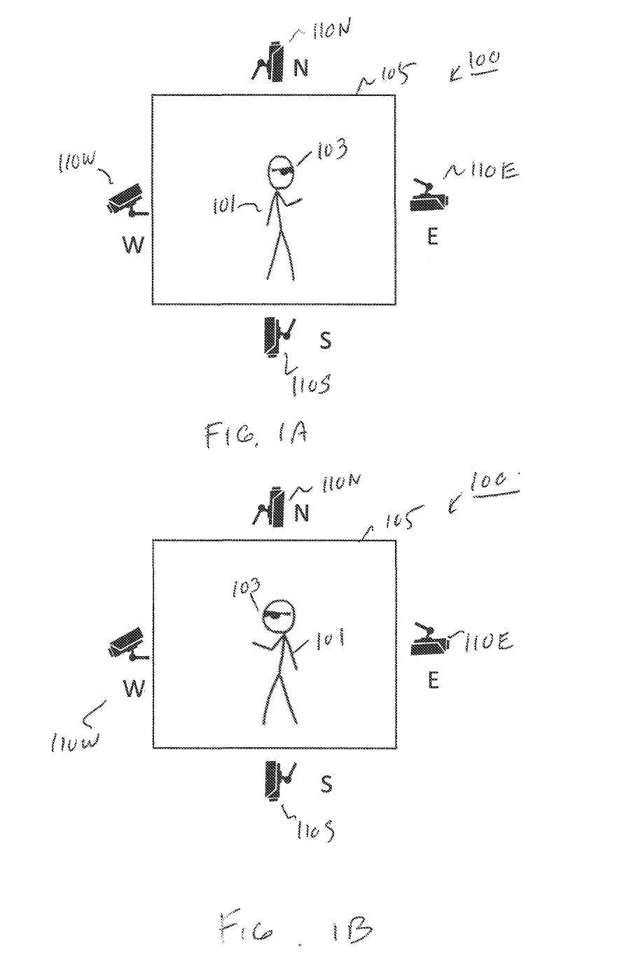

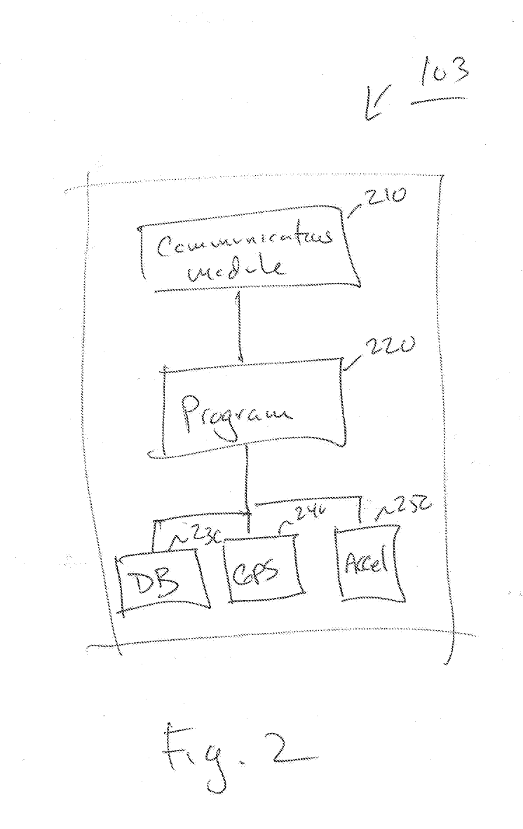

Further features and advantages of the invention, as well as the structure and operation of various embodiments of the invention, are described in detail below with reference to the accompanying FIGS. 1-2. Although the invention is described in the context of video presentation, the inventive concepts described herein may be utilized to present any type of perceptual information based on location and/or orientation such as, but not limited to audio information, tactile information, data, and still images.

Generally, the present invention facilitates an augmented reality through a mobile device that comprises a video display and optional audio output. For example, the mobile device may be a smartphone, tablet computer, or wearable electronic device such as a headset. The mobile device is permitted to dynamically move (perhaps through user assistance) through six degrees of freedom, i.e., forward/backward (surge), up/down (heave), and left/right (sway) (i.e., translation in the three x, y, and z, perpendicular axes) combined with rotation about the three perpendicular axes, often termed roll, pitch, and yaw (i.e., respective rotation through ω, φ, and κ angles about x, y, and z). Any instantaneous x, y, z position of the mobile device is herein referred to as a location. Any instantaneous ω, φ, and κ position is herein referred to as an orientation, e.g., the direction the mobile device is facing.

A plurality of video feeds are available from various video capture devices capturing live video and audio at different locations (and/or orientations) remote from the mobile device. Numerous types of video capture devices exist, the identification and implementation of which are apparent to one of ordinary skill in the art. The position and/or orientation of a video capture device may be fixed or permitted to change. Pre-recorded video feeds or computer-generated video feeds corresponding to other locations (and/or orientations) may supplement the plurality of video capture devices or replace one or more of the plurality of video capture devices capturing live feeds. Collectively, the video capture devices, pre-recorded video feeds, or computer-generated video feeds are herein referred to as video sources. In an embodiment of the invention, the video feeds of one or more of the video sources are obtained by the mobile device via a communications network, the identification and implementation of which is apparent to one of ordinary skill in the art. For example, a video capture device can be an IP camera located remotely and accessible through a local wireless network or the Internet. In another embodiment of the invention, pre-recorded video feeds or computer-generated video feeds may be stored at the mobile device or obtained from a remote server.

The present invention determines the location and orientation of the mobile device at a particular time, and uses such to select an applicable video source for display of its respective video feed, which for purposes of this description is presumed to include an audio feed as well. However, audio may be selected from an audio source not associated with the video source. As the location and/or orientation of the mobile device dynamically changes, the selection and display of the applicable video feed may change concurrently therewith. In other words, the selection and display of video feeds from applicable video sources is performed in real-time or near real-time with the movement of the mobile device. The location and orientation of the mobile device dictates the selection and display of a respective video feed from a plurality of available video sources.

FIGS. 1A and 1B illustrate a video feed system 100 according to an exemplary embodiment of the invention. Here, the video source environment has been greatly simplified to better illustrate the present invention. Video feed system 100 comprises four (4) video sources 110N, 110E, 110S, and 110W, which are live video feed cameras are located on the north, east, south, and west walls, respectively, of a house 105 (represented by a box). The video sources 110N, 110E, 110S, and 110W are oriented in the north, east, south, and west directions, respectively. The user 101 is located inside the house 105 and wears a mobile device 103. For example, mobile device 103 is smart glasses such as Google Glass. Referring to FIG. 1A, the user 101 is facing east. Thus, the mobile device 103 is oriented in the east direction. Video source 110E is selected and its video feed is displayed on the mobile device 103. Referring to FIG. 1B, the user 101 has turned and is now facing west. Thus, the mobile device 103 is oriented in the west direction. Video source 110W is now selected and its video feed is displayed on the mobile device 103. Accordingly, depending on the orientation of the mobile device 103 at any particular time, a video feed from one of the video sources 110N, 110E, 110S, and 110W will be displayed at that time.

In a scenario where the walls of the house 105 are completely obscured the view of the user 101, the present invention effectively enables the user 101 to “see through” the walls via the mobile device 103. In an embodiment of the invention, switching from one video source to another occurs at a specific boundary of orientation, e.g., northeast, southeast, southwest, and northwest. For example, as the orientation of the mobile device 103 rotates northward through the northeast boundary, the video feed displayed is switched from the video feed of the video source 110E to the video feed of the video source 110N. In another embodiment of the invention, depending on the orientation of the mobile device 103, two video feeds may be blended together, the implementation of which is apparent to one of ordinary skill in the art. For example, when the orientation of the mobile device 103 is northeast, half the video feed of the video source 110E is blended with half the video feed of the video source 110N. Blending can be performed in real-time providing seamless video display as the orientation of the mobile device 103 changes.

Location of the mobile device 103 can also be used. For example, selection of a particular video can factor how close the mobile device 103 is to one of the video sources 110N, 110E, 110S, or 110W. Automatic zooming (in or out) of the video feed can be enabled as the mobile device 103 travels closer or away from one of the video sources 110N, 110E, 110S, or 110W. In another embodiment of the invention, the user 101 may located outside of, and perhaps far away from, the house 105. Yet, the present invention provides the user 101 with the ability to access the various video feeds from the video sources 110N, 110E, 110S, or 110W as if the user 101 was in the house 105.

FIG. 2 illustrates a mobile device 103 according to an embodiment of the invention. Mobile device 103 includes all the elements and features typically associated with a mobile computing device, the identification and implementation of which are apparent to one of ordinary skill in the art, such as, but not limited to a processor (not shown) and display (not shown). However, in implementing the present inventive concepts, it is particularly noted that the mobile device 103 comprises a communications module 210, a program 220, and a database 230. The communications module 210 facilitates communication between the mobile device 103 and various video sources connected via a network. The program 220, e.g., an app, executes logic, on the processor, for selecting a particular video feed from the various video sources. The program 220 may also perform other functions such as, but not limited to, blending and zooming as noted above. However, one or more of these functions may be offloaded to a dedicated processor such as a video processor (not shown). The database 230 stores the location and/or orientation (if applicable) of the various video sources. This information may be downloaded via the communications module from a centralized server or directly from the video sources. For video sources that are able to change their position, e.g., a drone, and/or orientation, surveillance camera, the location and/or orientation information in the database 230 is updated periodically. In another embodiment of the invention, the database 230 (or a part thereof) is implemented not on the mobile device 230, but at a centralized server, which is accessible via the communications module 210.

In operation, the program 220 determines the location and orientation of the mobile device 103 via a global positing system (GPS) module 240 and one or more accelerometers 250. Alternatively, the location and orientation may be determined via a positioning system, the identification and implementation of which is apparent to one of ordinary skill in the art. The program 220 then retrieves the location and/or orientation of available video sources from the database 230. The program selects a video source by examining the location and/or orientation of the mobile device 103 against the locations and/or orientations of the video sources to decide which video feed should be displayed. For example, the program has specific rules or logic to dictate which video source to select including, but not limited to, ensuring the user 101 and video source are not oriented in conflicting directions and initially showing the closest appropriate video source. The program 220 sends a request, via the communications module 210, to the selected video source to obtain its respective video feed over the network. As the mobile device 103 is moved, its location is continually updated so that the program 220 can update its selection of a video feed (among the plurality of available video sources). In another embodiment of the invention, the program 220 is executed at a remote server.

Again, at any point the mobile devise 103 has a specific location and is facing a certain direction, i.e., its orientation. The location of the mobile device 103 can be found via GPS in terms of longitude and latitude (altitude is ignored for purposes of simplification). The orientation of the mobile device 103 can be found in terms of degrees (yaw only; roll and pitch are ignored for purposes of simplification). With these two pieces of information, the program 220 knows exactly where the device 103 is and which way the device 103 is facing; thus, where the user 101 is and which way the user 101 is facing. The program 220 can be pre-programmed to know the exact locations of the video sources, which may be fixed Internet protocol cameras (IPCs). To determine which of the IPCs' feed should be displayed, the program 200 must calculate which IPC has the view most similar to the user 101. Using geometry, the program 220 is able to determine the exact distance from the mobile device 103 to the IPCs. Once this information is found, the program 220 determines the angle of each IPC in relation to the device 103. The IPC closest to and/or with the angle most similar to the device 103, or some function thereof, will be selected and the video feed from said IPC will be displayed at the device 103.

For simplicity, assume that the user with the mobile device 103 is located at longitude and latitude (1,1). Assume IPC number one is located at (5.8, −0.6) and IPC number two is located at (−12.1, 4.2). The program is able to determine that IPC number one is located 4.8 units away in longitude direction and −1.6 units away in the latitude direction. And IPC number two is located −13.1 units away in the longitude direction and 3.2 units away in the latitude direction. With these adjusted values the program can treat the mobile device 103 as located at the origin of the coordinate system. Using these position values as two legs of a triangle and drawing a 90-degree angle with the latitude axis the program is able to determine the angle between the line of sight of the IPC and the latitude axis. This angle for IPC number one is 18.4 degrees and the angle for IPC number two is 13.7 degrees. The program associates the positive longitude axis with due north, the negative longitude axis with due south, the positive latitude with due west, and negative latitude with due east. In accordance with a compass due north is 0 or 360 degrees, west is 90 degrees, south is 180 degrees, and east is 270 degrees. With the values found above the program is able to determine where the IPCs are oriented. Since IPC number one has a positive latitude value and negative longitude value in relation to the mobile device the angle of 18.4 degrees can be subtracted from the closest axis, due east, to receive a new angle of 251.6 degrees. IPC number two has a negative latitude value and a positive longitude value in relation to the mobile device the angle of 13.7 degrees can be subtracted from the closest axis, due west, to receive a new angle of 76.3 degrees. These two new angles give the program a simple value to determine which IPC feed should be used. As the individual holding the mobile device turns, clockwise from due north, the program will show the feed from IPC number one until the person turns past 163.95 degrees, which is the halfway point between the two IPC angles. Then the program will begin to display the feed from IPC number two until the individual turns past 343 degrees, the halfway point between the two IPC angles, then the program will switch back to the feed from IPC number one.

The present invention is particularly useful in law enforcement or public safety. The present invention can be used to not only direct emergency personnel to the site, but to let them see what is going before they get there. Video sources can include a gun shot and other disturbance detector, e.g., motion sensor. When triggered, an arrow could be displayed for the emergency personnel, aligning them with the video source that was triggered and immediately have that video feed sent to them. This video source could then become the center of the program's algorithm, so if the emergency personnel saw suspects leaving the scene, they could then simply turn their mobile device in the way they saw the suspects go, and the algorithm would then show them the feed from the next closest video source.

For example, if a police officer is on first street and fifth avenue and a video source is triggered on fifth street and fifth avenue, due north, then when the office turned and faced north, he or she would see the feed from the video source on fifth street and fifth avenue. If the officer then saw the suspects heading west, and there was a video source on the corner of fifth street and fourth avenue, the officer could simply turn toward the west and the video feed would change. In this manner, the police officer could be moving toward the suspects while following them on video cameras.

In a retail setting, employees could move about a store, while looking around with the mobile device. Video cameras can be placed in strategic areas throughout the store so even if an employee's view was blocked, the video camera would allow them to see if a customer needed assistance. For example, in a large box store, an employee could be walking down aisle 3 and look toward their left, toward aisle 2. If there was a video camera positioned on or above aisle 2, the video feed could switch to show the scene on aisle 2. Additionally, since there is no limit as to how far away the video cameras can be, a regional manager with stores in several states could use the program's algorithm to look in on stores, even 100s of miles away, then simply scan to other stores by turning to their orientation.

In a security setting, a security guard could move about a campus with the mobile device. As the mobile device moves, video cameras inside buildings, on the other sides of walls, across the campus can all be automatically shown to the guard. For example, if a guard was walking along a path between warehouses on his campus, and each warehouse had a video camera inside, he could simply look inside each building by turning his mobile device in that direction.

The invention has been described herein using specific embodiments for the purposes of illustration only. It will be readily apparent to one of ordinary skill in the art, however, that the principles of the invention can be embodied in other ways. Therefore, the invention should not be regarded as being limited in scope to the specific embodiments disclosed herein, but instead as being fully commensurate in scope with the following claims.

We claim:

1. A method comprising the steps of:
determining a first location and a first orientation of a mobile device;
selecting, based on the determined first location and first orientation of the mobile device, a first video feed from among a plurality of video feeds associated with a plurality of video sources; and
displaying the first video feed at the mobile device.

2. The method of claim 1, wherein each video source is associated with a respective video source location and a respective video source orientation.

3. The method of claim 2, wherein the step of selecting comprises the step of comparing the first location and the first orientation of the mobile device to the respective video source location and the respective video source orientation of each video source.

4. The method of claim 1, further comprising the steps of:
determining a second location and second orientation of a mobile device;
selecting, based on the determined second location and second orientation of the mobile device, a second video feed from among a plurality of video feeds associated with a plurality of video sources; and
displaying the second video feed at the mobile device.

5. The method of claim 1, further comprising the steps of:
selecting, based on the determined first location and first orientation of the mobile device, a second video feed from among a plurality of video feeds associated with a plurality of video sources; and
displaying the first video feed combined with the second video feed at the mobile device.

6. The method of claim 1, further comprising the steps of:
augmenting the display of the first video feed with an indicator to move the mobile device to a second location and/or second orientation;
detecting movement of the mobile device to the second location and/or second orientation;
selecting, based on the second location and/or second orientation, a second video feed from among a plurality of video feeds associated with a plurality of video sources; and
displaying the second video feed at the mobile device.

7. The method of claim 6, wherein the step of augmenting the display occurs when a predetermined event is detected at a video source associated with the second video feed.

8. A non-transient computer readable medium containing program instructions for causing a computer to perform the method of:
determining a first location and a first orientation of a mobile device;
selecting, based on the determined first location and first orientation of the mobile device, a first video feed from among a plurality of video feeds associated with a plurality of video sources; and
displaying the first video feed at the mobile device.

9. The non-transient computer readable medium of claim 8, wherein each video source is associated with a respective video source location and a respective video source orientation.

10. The non-transient computer readable medium of claim 9, wherein the step of selecting comprises the step of comparing the first location and the first orientation of the mobile device to the respective video source location and the respective video source orientation of each video source.

11. The non-transient computer readable medium of claim 8, further comprising the steps of:
determining a second location and second orientation of a mobile device;
selecting, based on the determined second location and second orientation of the mobile device, a second video feed from among a plurality of video feeds associated with a plurality of video sources; and
displaying the second video feed at the mobile device.

12. The non-transient computer readable medium of claim 8, further comprising the steps of:
selecting, based on the determined first location and first orientation of the mobile device, a second video feed from among a plurality of video feeds associated with a plurality of video sources; and
displaying the first video feed combined with the second video feed at the mobile device.

13. The non-transient computer readable medium of claim 8, further comprising the steps of:
augmenting the display of the first video feed with an indicator to move the mobile device to a second location and/or second orientation;
detecting movement of the mobile device to the second location and/or second orientation;
selecting, based on the second location and/or second orientation, a second video feed from among a plurality of video feeds associated with a plurality of video sources; and
displaying the second video feed at the mobile device.

14. The non-transient computer readable medium of claim 13, wherein the step of augmenting the display occurs when a predetermined event is detected at a video source associated with the second video feed.

15. A mobile device comprising:
means for determining location of the mobile device;
means for determining orientation of the mobile device;
a display;
a processor; and
a non-transient computer readable medium containing program instructions for causing the processor to:
determine a first location and a first orientation of a mobile device;
select, based on the determined first location and first orientation of the mobile device, a first video feed from among a plurality of video feeds associated with a plurality of video sources; and
display the first video feed on the display.

16. The mobile device of claim 15, wherein each video source is associated with a respective video source location and a respective video source orientation.

17. The mobile device of claim 15, wherein the program instructions further cause the processor to:
determine a second location and second orientation of a mobile device;
select, based on the determined second location and second orientation of the mobile device, a second video feed from among a plurality of video feeds associated with a plurality of video sources; and
display the second video feed on the display.

18. The mobile device of claim 15, wherein the program instructions further cause the processor to:
select, based on the determined first location and first orientation of the mobile device, a second video feed from among a plurality of video feeds associated with a plurality of video sources; and
display the first video feed combined with the second video feed on the display.

19. The mobile device of claim 15, wherein the program instructions further cause the processor to:
augment the display of the first video feed with an indicator to move the mobile device to a second location and/or second orientation;
detect movement of the mobile device to the second location and/or second orientation;
select, based on the second location and/or second orientation, a second video feed from among a plurality of video feeds associated with a plurality of video sources; and
display the second video feed on the display.
